(19) United States
(12) Patent Application Publication
(10) Pub. No.: US 2005/0169646 A1
(43) Pub. Date: Aug. 4, 2005

(54) Lincoln distributed optical receiver array

(75) Inventors: Roy S. Bondurant, Carlisle, MA (US); Don M. Boroson, Needham, MA (US); Daniel V. Murphy, Bedford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Massachusetts Institute of Technology, Cambridge, MA (US)

(21) Appl. No.: 10/768,395

(22) Filed: Jan. 30, 2004

(51) Int. Cl. H04B 10/06

(52) U.S. Cl. 398/202

(57) ABSTRACT

An array of spatially-separated optical detectors is configured to receive a free-space optical communication signal from a remote source. Each optical detector of the array includes an optical system and an array of light sensors. The optical system collects a portion of light received from the remote source and directs it toward the array of light sensors. The array of light sensors, in turn, converts the collected portion of light to one or more electrical, detected signals corresponding to the collected portion of light. A processor is coupled to the array of spatially-separated optical detectors, receiving the detected signals and combining the received signals to obtain information borne by the received optical communication signal.

### GOVERNMENT SUPPORT

The invention was supported, in whole or in part, by a grant F19628-00-C-0002 from NASA. The Government has certain rights in the invention.

### BACKGROUND OF THE INVENTION

Free-space optical communications are being pursued in numerous applications, from terrestrial communications links between buildings or towns, to space communications links. Some of the advantages offered by free-space optical communications include an extremely narrow beamwidth to substantially reduce spreading loss compared to other Radio Frequency (RF) communication alternatives. Additionally, optical communications links tend to occupy less space, and utilize less mass and power compared to other RF communication alternatives. For at least these advantages, optical communications links will figure prominently in future space exploration. These communications links will include interplanetary communications links required to support exploratory missions to Mars and other planets. Added to these advantages, is the prospect of providing 10-100 times higher data return.

Unfortunately, the received optical power densities for some free-space signals are extremely low. In particular, an optical source transmitting from Mars would require a highly sensitive optical receiver on Earth. The challenge for an optical receiver is to collect enough of the incident photons to detect and demodulate the transmitted signal. Currently available alternatives include astronomical telescopes, such as the large reflector telescopes having apertures from 10 to 100 square meters. In operation, an optical detector, such as a photodiode would be placed in the focal plane of a large telescope to convert the focused light into an electrical signal for further processing and/or demodulation. This alternative, however, is an unlikely candidate due to the limited number of telescopes and the excessive cost and complexity of constructing and maintaining such devices.

Further complicating the detection of extremely low power optical communications signals is interference due to background light sources such as the sun, the moon, and planets. In particular, these background light sources causes noise within an optical receiver. The noise may appear as a steady random background signal that tends to reduce the minimum sensitivity of the optical receiver and mask the intended received signal.

Others have attempted to use an array of optical receivers (e.g., telescopes) each including a light sensor. These, however, would suffer due to their limited optical sensitivity values (e.g., the minimum number of photons to produce an electrical response) considering the low power-levels and interference sources. Additionally, as the output signals from several of these light detectors are combined, the noise contributions also combine, tending to further reduce the detection sensitivity of the receiver.

### SUMMARY OF THE INVENTION

The present invention solves the problems of the prior art by providing an array of photon counting sensors within each element of an array of telescopes. The resulting array of arrays yields an optical receiver that is well adapted for receiving extremely low power optical communication signals.

An optical communications receiver includes an array of spatially-separated optical detectors configured to receive an optical communication signal from a remote source. Each optical detector of the array includes an optical system and an array of light sensors. The optical system collects a portion of light received from the remote source and directs it toward the array of light sensors. Generally, the optical detector includes a telescope optically coupled to the array of light sensors. In some embodiments, the telescope includes a solar baffle to allow the receiver to operate when the remote source is close to the sun.

The array of light sensors, in turn, converts the collected portion of light into electrical signals that correspond to the detected portion of light. The electrical signals are then distributed to a processor, which uses the detected signals to obtain information borne by the received optical communication signal. The array of light sensors can include an array of photon-counting sensors that provide an output signal indicative of the number of photons received. In some embodiments, the array of light sensors includes Avalanche PhotoDiode (APD) sensors. The APD sensors can be operated in a, so called, non-linear “Geiger” mode in which they behave as photon counting sensors. Further, the light sensors, such as the APD sensors, can be housed on a monolithic substrate.

In order to collect light from the remote source, the receiver generally includes an adjustable mount. The mount is used to steer one or more of the elements of the optical detector array, thereby aiming them toward the remote source. To facilitate operation and to ensure accurate signal acquisition and tracking, the adjustable mount can be remotely controlled.

The receiver may be configured to receive optical communication signals that include information modulated at a rate of at least 1 megabit per second (Mbps). For example, the information can be modulated using M-ary, pulse-position-modulation (M-PPM). Still further, the receiver is configured to receive optical communication signals having an associated optical wavelength that is longer than about 1 micrometer (μm).

In general, the receiver includes a detector processor coupled to the array of light sensors. The detector processor receives the electrical detected signal and uses that signal to determine the information borne on the received optical signal. In some embodiments, multiple processors are used. For example, a respective local processor can be provided and coupled to each one of the spatially-separated optical detectors. The local processor can be used for processing at least a portion of the detected communication signals.

In some applications, the optical detectors of the array may be geographically separated at modest, or even great distances. Accordingly, the processors can be coupled to the optical detectors using a network, such as a Local-Area Network (LAN).

In general, photons corresponding to the same bit of information in the optical communications signal should be combined together. Photons from the same bit, however, may be received at different times, due to the location of the remote source and the geographic location and orientation of the optical detector elements of the array. Accordingly, processors can be used to determine a respective delay value for each of the number of spatially-separated optical detectors. For example, the processor can calibrate the receiver by measuring the delay values. Alternatively, or in addition, the processor can calibrate the receiver by calculating delay values, usually with some knowledge of the geometry involved. Alternatively, or in addition, a time reference can be provided within the received optical communication signal. The time reference can be used to facilitate determination of the delay values.

A respective delay value, once determined, can be applied to each of the respective detected signals thereby forming delay-corrected detected signals. Further, the delay-corrected detected signals can be combined, for example by aggregation.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of one embodiment of the invention including an array of optical detectors, each element of the array coupled to a respective array of light detectors;

FIG. 1 is a schematic diagram of one embodiment of the invention including an array of optical detectors, each element of the array coupled to a respective array of light detectors;

FIG. 2 is a schematic diagram of one of the elements of the array of FIG. 1;

FIG. 3 is a plan view of an exemplary embodiment of the invention including a two-dimensional array of optical detectors;

FIG. 4 is a plan view of an exemplary embodiment of the array of light detectors of FIGS. 1 and 3;

FIG. 5 is a schematic diagram of one of the light detectors of the array of light detectors of FIG. 4;

FIG. 6 is a graph illustrating an exemplary output signal provided by the light detector of FIG. 5 in response to receiving an optical signal;

FIG. 7 is a graph illustrating an exemplary M-ary Pulse-Position Modulated (M-PPM) signal;

FIG. 8 is perspective view of one embodiment of the invention using a steerable planar array;

FIG. 9 is a perspective view of an alternative embodiment of the invention; and

FIGS. 10A and 10B are graphs respectively illustrating exemplary delayed output signals of the light detectors and their corresponding delay-corrected output signals.

### DETAILED DESCRIPTION OF THE INVENTION

A description of preferred embodiments of the invention follows.

The present invention provides an array of modestly sized telescopes, each adapted to include an array of photon counting detectors. The resulting array of arrays yields an optical receiver that is well adapted for receiving extremely low power communication signals.

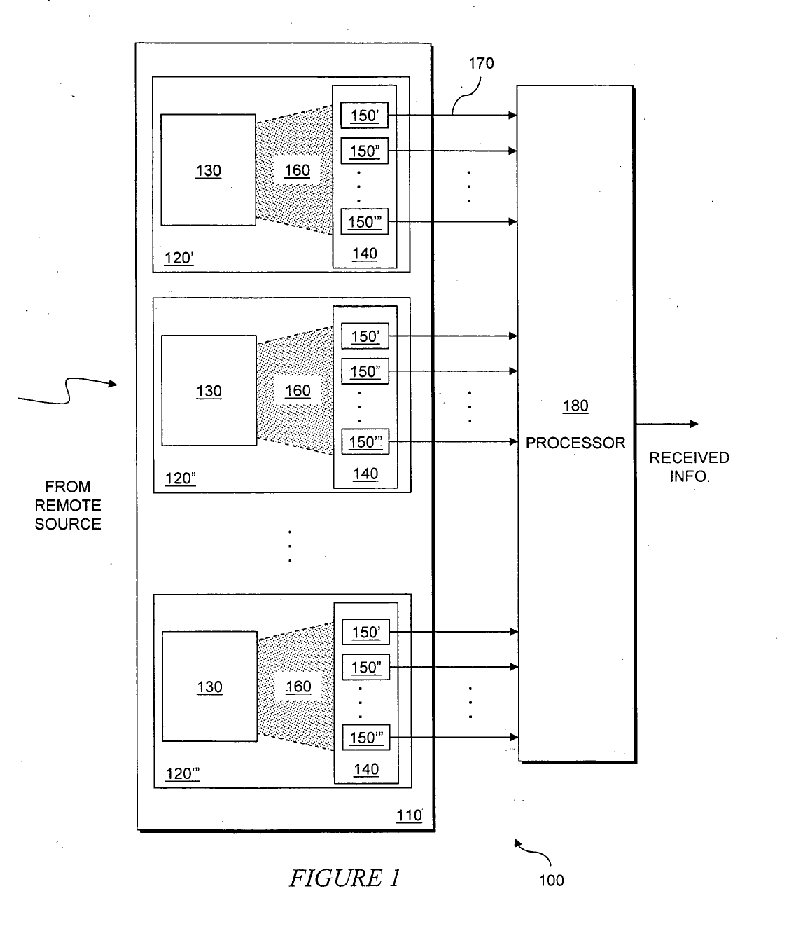

A schematic representation of an optical communications receiver is illustrated in FIG. 1. The optical communications receiver 100 includes an optical array 110 having a number of spatially-separated optical detectors 120. The optical array 150″, 150′″ (generally 150). The optical system 130 collects a portion of light received from the remote source and directs it toward the light-sensing array 140. A shaded region 160 represents the light directed from the optical system 130 to the light-sensing array 140. Notably, the dimensions of the different components are not necessarily drawn to scale. For example, the optical system 130 may be substantially larger than the light-sensing array 140, as described in more detail below.

In general, the light sensors 150 of the light sensing array 140 convert received optical power into electrical power, independently of the energy of the transmitted optical signal. Thus, the light sensors 150 each generate an electrical, or detected signal 170 (e.g., a voltage and/or a current) in response to receiving a portion of the light coupled from the optical source 130. Some examples of light sensors 150 include photodiodes, PIN photodiodes, phototransistors, Avalanche PhotoDiodes (APDs), Charged-Coupled Devices (CCDs), and photo-multiplier tubes.

In particular, as will be discussed in greater detail below, Geiger-mode Avalanche PhotoDiodes (APD) can be used as photon counting light detectors. Limitations associated with a dead time in each Geiger-mode APD are removed by providing an array having a sufficiently large number of APDs and spreading the received light across the array of APDs. Using this technique, individual APDs of the array “fire” at different times during reception of an optical signal, such that at any given instant, a number of APDs are charged and ready to fire, while others may still be charging.

In some embodiments, each of the light sensors 150 is electrically coupled to a processor 180. The processor 180 receives detected signals 170 from one or more of the light sensors 150 coupled to it. The processor 180 uses the received signals to determine information borne by the received optical signal from the remote source. In other embodiments, multiple processors 180 can be used. For example, a different respective local processor (not shown) can be coupled to the light sensors 150 of each optical detector 120. The local processors can serve numerous functions, described in more detail below. In general, however, the local processors can process a portion of the detected communications signal. Each of the local processors can provide a single output signal representative of the light received by the associated detector 120. Ultimately, the central processor 180 receives outputs from the local processors and provides, among other things, an output signal including the received information obtained from the remote source.

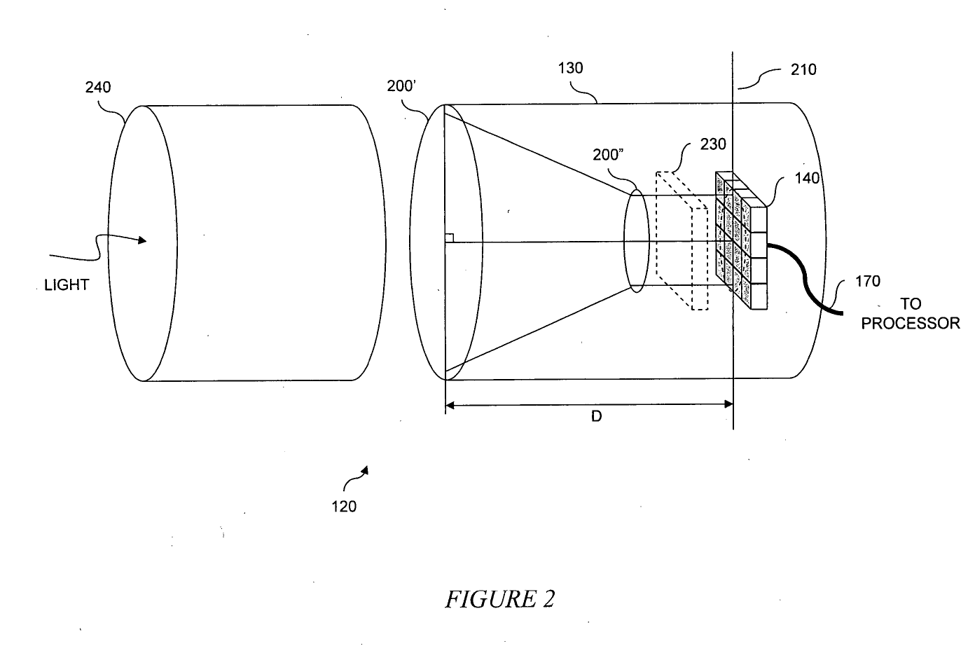

In more detail, referring now to FIG. 2, the optical system 130 can be a conventional telescope. For example, the optical system 130 can be a reflector telescope, such as model series C10-NGT, Newtonian reflector, manufactured by Celestron of Torrance, Calif. Alternatively, or in addition, the optical system 130 can include a refractor telescope, such as model series CR-4, also manufactured by Celestron. Still further, the optical system 130 can include a compound (i.e., catadioptric) telescope, such as model C5-SGT Schmidt-Cassegrain, also manufactured by Celestron. Any of a number of other low-cost, commercially-available telescopes, or custom telescopes may be used.

Essentially, any of the optical systems 130 discussed above provides one or more lenses and/or mirrors 200′, 200″ (generally 200) for collecting light and focusing the light onto a focal plane 210. Generally, one of the lenses/mirrors 200 is referred to as the objective of the telescope, defining an aperture that corresponds to the amount of light captured by the device. For example, in FIG. 2, a first lens 200′ forms an aperture defined by the surface area covered by the lens (e.g., A=πr², r=diameter of lens/mirror 200′). As illustrated, the light-sensing array 140 can be located at the focal plane 210. Accordingly, the captured light is imaged, or optically coupled onto the light-sensing array 140. The focal plane is defined by the geometry of the particular optical system 130, such as the focal distance from the objective lens 200′ in a refractor telescope. As illustrated in this figure, the diameter of the light-sensing array 140 is typically much smaller than the aperture, as the light is focused to a spot. Focusing in this manner provides optical gain to a weak received optical signal.

As illustrated, the optical system 130 can optionally include a solar baffle 240. A solar baffle 240 is typically a hollow cylinder aligned with the optical axis of the optical system 130 and extending outward from the detector 120 by a predetermined distance. The solar baffle 240 can be configured to permit reception of weak optical signals from a remote source operating at an observation angle close to the sun. In particular, planetary trajectories include regions that are observable as being close to the sun. Accordingly, a solar baffle 240 is an important feature for an optical system 130 configured to support interplanetary optical communications. As the aperture of each individual optical system 130 is relatively small (e.g., 15 inches, and not the 3-10 meter diameter apertures usually provided in astronomical observatories), use of the solar baffle 240 can permit operations closer to the sun (i.e., to within a few degrees, or less of the sun).

Notably, an optional optical filter 230 can also be provided within the optical system 130. The optical filter 230 can be configured to selectively attenuate a preferred range of optical wavelengths, thereby sheltering the focal plane array 140 from some of the unwanted light. However, for very weak optical signals, even the passband loss of an optical filter may be too great, resulting in loss of the desired signal. Accordingly, operation without an optical filter 230 may be better suited for the weakest received signals.

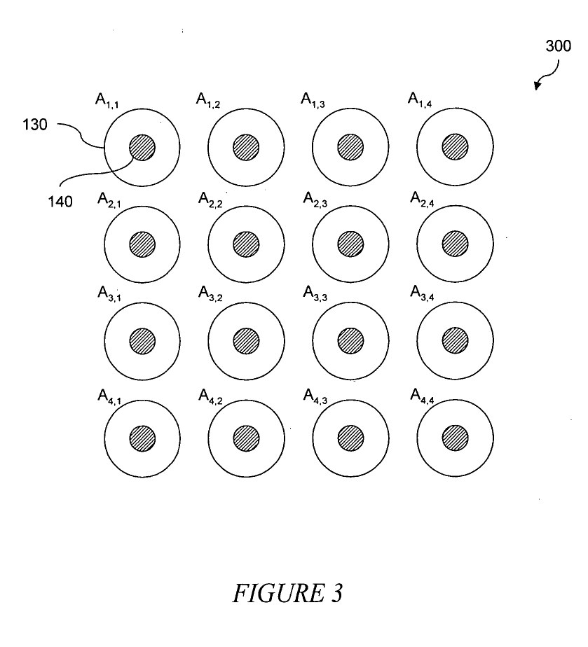

In general, an optical receiver array 300, such as the one shown in FIG. 3, includes a number of optical detectors 120, such as the “m×n” detectors shown. The detectors 120 can be arranged in a two-dimensional array, as shown, or more generally in any desired pattern. The important feature of the array for the communication receiver application is the total array aperture, defined by the sum of the individual apertures A_{1,l} through A_{m,n} (generally Aᵢⱼ) of each optical detector 120. Thus, the total aperture of the optical receiver 300 is defined by equation 1.

$$Aperture = {\sum }_{i = 1}^{n} {\sum }_{j = 1}^{m} {A}_{i , j} \qquad ( 1 )$$

The performance of the optical communications receiver depends upon the total amount of light received from the remote source. Thus, an optical communications receiver need only capture transmitted photons—not render a clear image. This requirement greatly simplifies design of the optical components and allows for the use of a large number of small aperture optical systems, rather the large and more costly devices.

As described in relation to FIG. 1, a light-sensing array 140 generally includes a number of individual light sensors 150. In some embodiments, the light-sensing array 140 can include individual APDs mounted to a planar circuit board. More preferably, however, a light-sensing array 140 is a monolithic array, in which the number of light sensors are integrally formed together upon the same substrate. In some embodiments, the monolithic light-sensing arrays 140 include arrays that are fabricated in semiconductor substrates, such as silicon, gallium, and InGaAs.

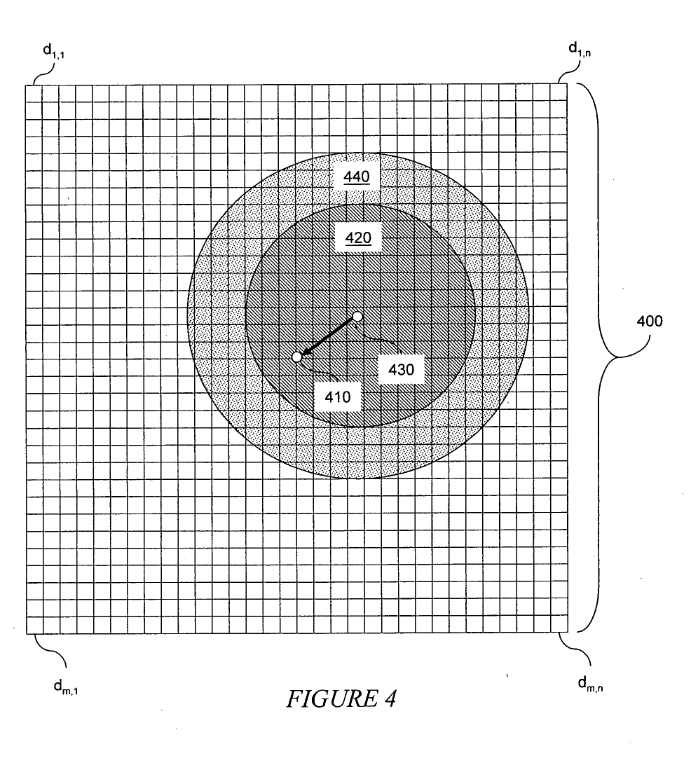

The light-sensing array 140 is preferably planar, such that the entire array 140 can reside within the focal plane of an optical system 130. One exemplary planar light-sensing array 400 is shown in FIG. 4 including 1,024 sensors arranged in a 32×32 grid. Other arrays can be formed with a greater or fewer numbers of sensors. The physical layout of the array 400 can take any number of forms, such as a square, as shown, a rectangle, a circle, or an oval. In some embodiments, the sensors of the array 400 are arranged in a circular or oval pattern. Such a pattern is generally better match to the focused spot size of most optical systems 130.

As shown, light from the remote optical source is focused by the optical system 130 onto the array 400, thereby forming a first spot 420. The spot 420 represents an optical intensity distribution incident upon the surface of the array 400. The spot 420 defines a geometric center 430 that may or, more likely, may not be aligned with a geometric center 410 of the array 400. The coincidence of the two centers 410, 430 depends largely upon the pointing accuracy of the optical detector 120. As the initial pointing is typically mechanical, some offset should be expected.

In some embodiments, the processor 180 determines the approximate center 430 of the detected spot (e.g., by first determining the locus of array sensors receiving the optical communications signal, and then determining which sensors corresponds to the approximate center of the determined locus). The array center 410 is generally fixed and can be registered with the processor 180. The processor 180, in turn, can determine an error signal using the determined center 420 of the received spot 430 and the known center 410 of the array 400. The error signal can, in turn, be used to realign the optical detector 120. For example, the processor 180 can be connected in a continuous feedback loop to a servo device for steering the optical detector 120. In this manner, the processor 180 helps the receiver 100 to acquire, align, and track a remote optical source.

The processor 180 can also determine which sensors are receiving the signal, leaving those sensors on, while turning off and/or ignoring detector output signals from the other sensors of the array 400. For example, the processor 180 can determine that the signal is being received by all of the sensors within the first shaded circle 420. Similarly, if the received signal is blurred or if there is some minor movement, the processor 180 can determine that the signal is being received by all of the sensors within the second shaded circle 440. Additionally, to account for some inaccuracies, the output signals from sensors extending over a slightly larger region than either shaded circle 420, 440 (e.g., as a “buffer zone”) can also be considered by the processor 180 when determining the received signal to avoid discounting any of the available photons.

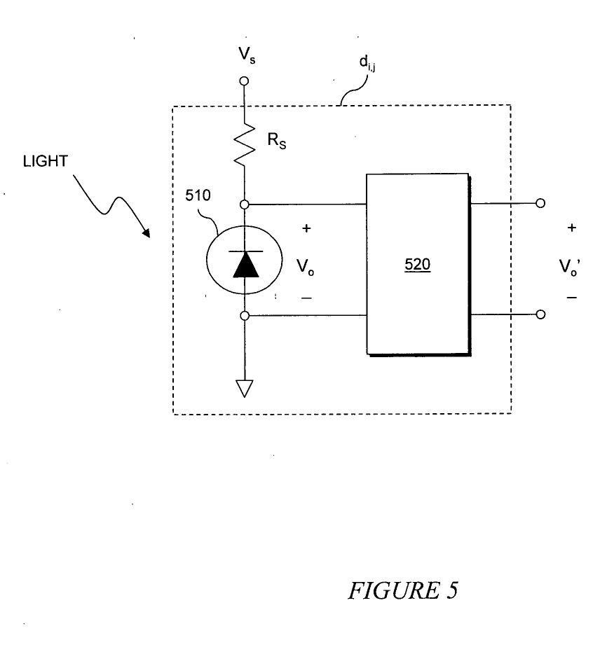

Each of the array sensors dᵢⱼ includes a light sensor including circuitry configured to detect and respond to incident photons. In particular, referring to FIG. 5, an array sensor may include an APD 510, which is sensitive to individual photons and is thus well suited to very low signal conditions. The APD 510 is reverse biased using a bias source, shown as Vₛ. A bias network, such as a series resistor Rₛ, is coupled between the bias source Vₛ and the reverse biased APD 510. A voltage V₀ appears across the junction of the APD 510.

In operation, the APD 510 is initially charged by an electric field provided by the bias source Vₛ. Upon detection of a photon, a hole-electron pair is generated and accelerated across the APD junction by the electric field. As the hole and electron each travels towards its respective side of the junction, they create additional hole-electron pairs that are also similarly accelerated, and so on. In this manner, the APD 510 is operated in a so called “Geiger mode.” That is, the receipt of one or more photons initiates the above process referred to as avalanche breakdown.

In general, a Geiger-mode APD “fires” in response to receiving an optical input (e.g., a photon). Unfortunately, the Geiger-mode APD is unable to fire again for a substantial period of time until it charges back up (similar to an electronic flash on a camera). This delay may be an acceptable limitation for imaging applications, where Geiger-mode APDs are commonly used, but it is quite limiting for optical communications. For example, a typical delay for a Geiger-mode APD may be on the order of 1 μsec. Thus, when the Geiger-mode APD is fired once, it remains unable to respond to any other optical input for at least the 1 μsec “dead time.” As communications at high data rates at hundreds of megahertz or even higher are common place, such a dead time would be intolerable. Either communication rates would be limited to very low data rates, or bits of information would be lost resulting in an excessive bit error rate.

However, Geiger mode operation is advantageously well adapted for photon counting—although it is not exactly photon counting in the sense of determining precisely how many photons were received. Rather, the Geiger-mode APD 510 responds equally to the receipt of one or more photons at any given time. The avalanche breakdown of the APD 510 produces substantially the same electrical current, and corresponding change to the electrical field across the junction, regardless of whether a single photon was detected, or a number of photons. As the bias source Vₛ continues to reverse bias the APD 510, the electric field is reestablished and, after the recharging delay, the APD 510 is once again ready to respond to one or more incident photons as described above.

In addition to the bias network Rₛ, the array sensor can include additional circuitry, such as a network 520 coupled in shunt with the APD 510. The network 520 can include signal conditioning devices, such as electrical filters to sharpen rise times and/or reduce ripple. Alternatively, or in addition, the network 520 can include quenching circuitry configured to more rapidly charge the APD 510 to a ready state, after the occurrence of an avalanche breakdown. Additionally, the network 520 can include more advanced circuitry, receiving an input from a local timing reference, to register the time receipt of each pulse.

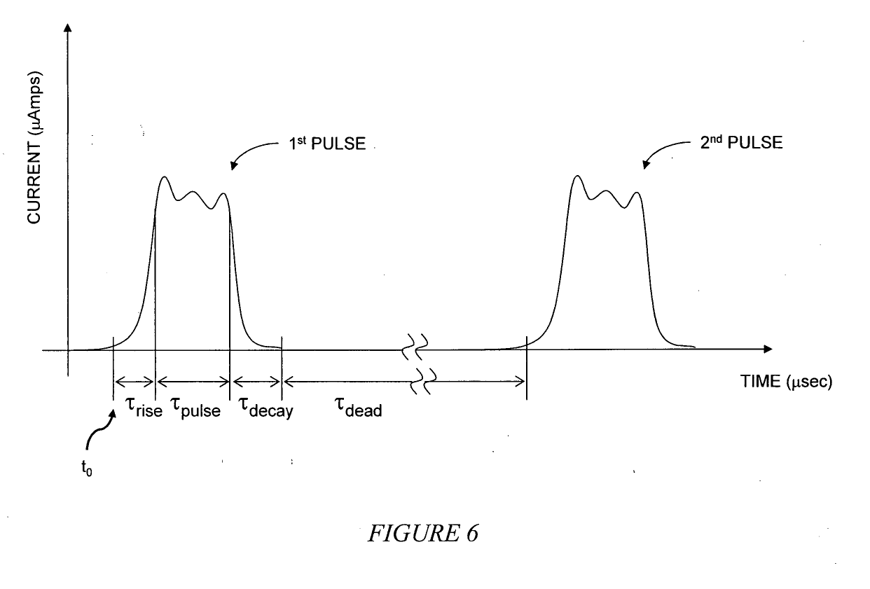

An exemplary electrical detector output signal is graphically illustrated in FIG. 6. The amplitude of the output signal current is plotted in micro-Amps, versus time, measured in micro-seconds. At approximately a reference time t₀, the associated light detector detects one or more incident photons. The avalanche breakdown process begins within the APD 510, as described above, and results in an increase in the current generated to some maximum value Iₘₐₓ. Typically, the rise time τᵣᵢₛₑ of the output current is very rapid (e.g., nano-seconds). The output current may remain at an approximate maximum value for some period of time, referred to as a pulse width τₚᵤₗₛₑ. The amplitude of the current again returns to substantially zero within a decay time τ_{decay}. Notably, the Geiger-mode APD 510 remains in a recharging state, unable to respond to subsequently received photons for a period of time τ_{dead} while the APD 510 again charges in preparation of the next detection event. Should any photons be received during the recharging time, the APD 510 provides no substantial electrical response, effectively ignoring the received photons. After the recharging time, the APD 510 is again ready to respond as described above and as shown for the second pulse.

Typically, Geiger-mode APDs had been used in imaging and other applications, in which a “snapshot” type of response was acceptable. One such imaging application is described in U.S. Pat. No. 5,892,575 issued to Marino and incorporated herein by reference in its entirety. Unfortunately, this type of response is not acceptable for communications receivers operating at data rates greater than the charge time of the APD. However, by using a large number of APDs in the optical receiver, and by carefully spreading the received light across the APDs, the APDs will respond at different times to the same signal. Thus, as some of the large number of APDs are recharging, others will be recharged and ready to respond to the next optical pulse.

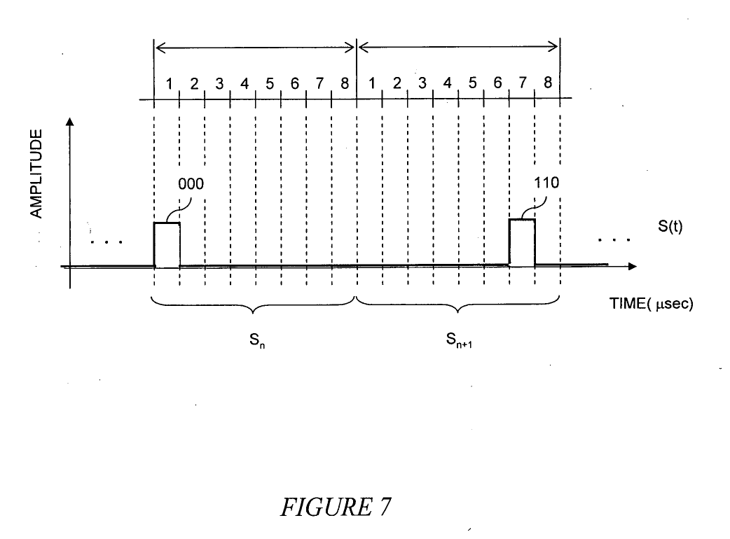

In some embodiments, the optical source is modulated using a Pulse Position Modulation (PPM). That is, the source data bits are encoded at the remote source to correspond to the position of a pulse at one of a number of predefined positions within a symbol period. Referring now to FIG. 7, two exemplary symbols of an 8-ary PPM signal are shown. A first symbol period Sn defines a number of possible pulse positions (i.e., 2³=8) shown as positions 1-8. The first symbol occurs in the 1^{st} pulse position corresponding to a binary value of ‘000.’ Thus, the pulse position of a symbol, once determined, can be decoded into the originating source bits (i.e., 000). Similarly, a second, subsequent symbol Sₙ₊₁ includes a pulse occurring in the 7^{th} position. This position corresponds to a binary value of ‘110.’ In general, the number of positions can be selected as any of a number of different values. Thus, the term M-ary PPM modulation refers to PPM using a symbol set of M pulse positions. Such an M-ary PPM modulation scheme is particularly well suited to communication schemes configured to conserve photons. Notice that the pulse duration, the time during which photons would be transmitted from the source, represents only a small portion of the symbol period.

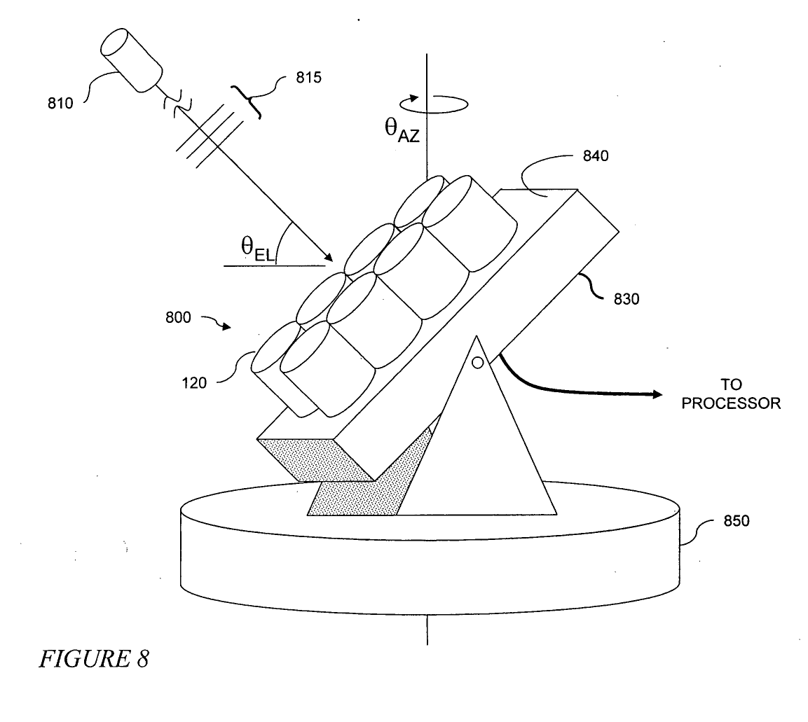

In some embodiments, the optical communications receiver includes a fixed, planar optical detector array 800, as shown in FIG. 8. As its name suggests, the fixed-planar optical detector array 800 includes a number of optical detector array elements 120 arranged on a fixed frame 830. Importantly, the frame 830 defines a planar array surface 840, to which the optical detector array elements 120 are attached. Preferably, the elements 120 are securedly attached to the frame 830 so that they can be aimed with the necessary precision. Notably, the optical axis of the elements 120 is perpendicular to the surface of the plane 840.

In order to steer or point the optical detectors 120 to an intended remote optical source 810, the frame 830 together with the attached elements 120 is coupled to a steerable mount 850, or pedestal. In some embodiments, the mount 850 is a gimbal mount permitting azimuth and elevation positioning. Proper alignment occurs when the planar array surface 840 is perpendicular to a ray traced from the array 800 to the remote source 810. When proper alignment occurs, each element 120 of the array receives the optical signal at substantially the same time. That is, each of the equi-phase fronts 815 of the propagating optical signal simultaneously illuminates the extent of the planar array surface 840, such that all elements 120 will substantially simultaneously receive photons corresponding to the same transmitted pulse. As shown, the detected electrical signal from the sensors of the optical detector array elements is coupled to a processor (not shown). For this embodiment, the processor can aggregate the outputs from all of the light-detector array elements to detect and demodulate the optical signal.

As with all photodiodes, the APDs 510 will exhibit some noise, for example due to “dark” current. The dark current results from a response, or avalanche breakdown, occurring without first having received an incident photon. Typically, the dark current can be controlled to a tolerable level through careful design of the APD 510 and/or by cooling the APD 510 during operation. Additionally, the APDs 510 may respond to stray photons from unwanted background radiation. For example, during daytime operation, the solar scattering due to the earth's atmosphere provides additional optical noise. The invention capitalizes on the law of large numbers by using a large number of light sensors to detect the intended optical signal. For example, an optical receiver can include an array of four or more telescopes, each having a corresponding 1,024 sensor APD array. Thus, the resulting receiver uses more than 4,096 sensors to detect the same optical signal.

Additionally, as dark current and background radiation is incident upon the APDs, the individual sensors will fire at random intervals. As an optical pulse is received from the remote source, some of the APDs will fire coincident with the time of the received pulse. Thus, as output signals of the large number of APDs are interpreted by the processor, there will be a constant level of noise depending upon the amount of background radiation. Notably, however, a correlation will be evident indicating the presence of a received pulse, as more APDs will fire coincident with the time of the pulse.

Thus, as some sensors will respond to dark current, and others to optical noise, the law of large numbers predicts that there will be a measurable probability that more of the light sensors will respond in the presence of photons from the intended remote source. Thus, more of the large number of light sensors will respond when the optical signal is present, such that the processor can determine when an optical signal is present by observing the output signals from substantially all of the light sensors. Importantly, as the APDs 510 are operated in Geiger mode, their results can be combined, or aggregated without incurring additional noise penalty, because the actual signals need not be combined. Rather, in Geiger, or photon counting mode, the number of detected photon pulses together with an associated pulse reception time value are used by the processor.

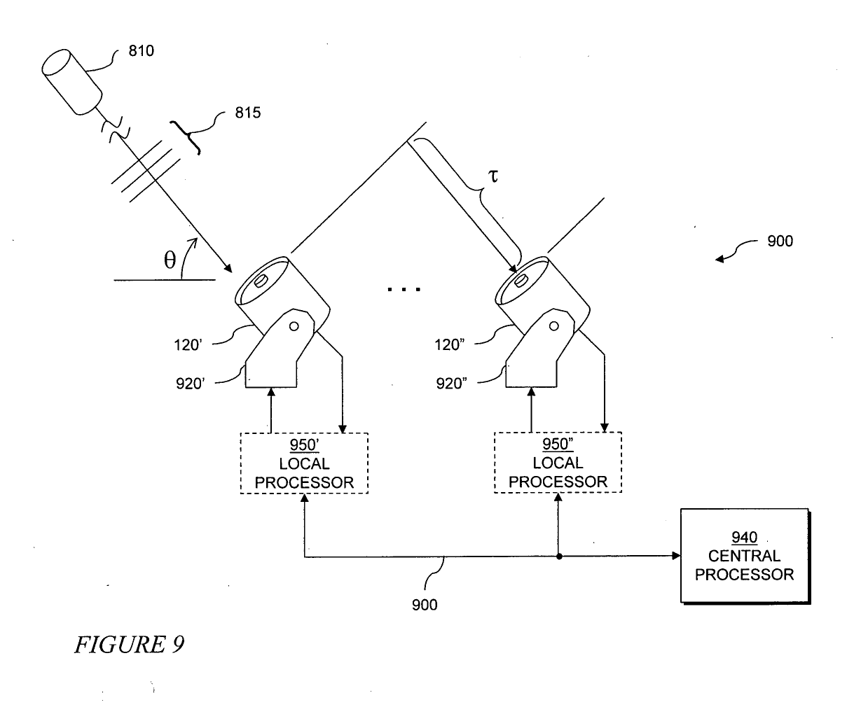

In other embodiments, the optical communications receiver includes an optical detector array 900 illustrated in FIG. 9. The optical detector array 900 includes a number of optical detector array elements 120′, 120″ (generally 120) arranged without any special relationship to each other. Further, each optical detector array element 120 includes its own steerable mount, or pedestal 920′, 920″ (generally 920). As described above, the mount can include a gimbal that enables positioning in azimuth and elevation. As each of the optical detectors 120 is spatially-separated and individually steered to the intended remote optical source 810, the special relationship ensuring that each detector 120 receives the same signal at the same time, is not preserved. Thus, as one of the equi-phase fronts 815 from the remote source 810 is received at the first detector 120′ at a first reference time, the same phase front will be received the other detectors 120 of the array 900 at different times. For example, as photons from one pulse of the optical signal are received at the first detector 120′, corresponding photons from the same pulse are not received at the second detector 120″ until the wavefront travels the additional distance resulting in an corresponding time delay τ.

The receiver 900 includes a central processor 940 coupled to each of the array elements 120. Generally, the processor 940 determines the presence of an optical pulse as described above in relation to FIG. 8; however, an additional step is required by the processor 940 to account for the relative time delays between the different elements of the array 900. For example, the processor 940 can effectively subtract delays, thereby aligning the detected signals received by the different array elements 920 with the same symbol transmitted from the optical source 810.

The processor 940 can be coupled to each of the array elements using a direct connection, such as a cable. Alternatively, the processor 940 can be coupled to the array elements using a network, such as a dial-up network, a leased line, a local area network, and/or a wide area network, such as the Internet. Being able to leverage available communication infrastructure, such as the telephone lines or the Internet is particularly beneficial for embodiments in which the optical detector array elements are disbursed across a geographical region. The content of the communications between the processor 940 and the elements includes one or more of the following: transmission of the detected electrical signals from the array elements to the processor; provision by the processor of a timing signal, such as a reference clock; provision of steering control signals to one or more mounts of the array; and feedback signals to track a received signal.

In some embodiments, the array 900 includes a respective local processor 950′, 950″ (generally 950) coupled to each of the array elements 920. The local processor 950 can perform at least a portion of the processing locally. Additional processing can be performed at the remote central processor 940. For example, the processing performed for each light detector array can be performed by the local processors 950; whereas, processing to compensate for time delays, and symbol detection can be controlled at the central processor.

The array 900 also includes a time reference source, such as a clock. The time reference source can be used by the local processors 950 to align detected signals due to photons received at different array elements 920 to the same corresponding symbols. The time reference source can also be used by the central processor 940, as required, to determine the location of a pulse within a PPM symbol frame. As optical communications are well suited for high-speed operation, data rates are anticipated at 1-10 megabits per second and above. Thus, the time reference source must be at a sufficiently high frequency to support operation at the above-mentioned data rates. For example, the reference clock signal can be a clock signal at 1 gigahertz, or above.

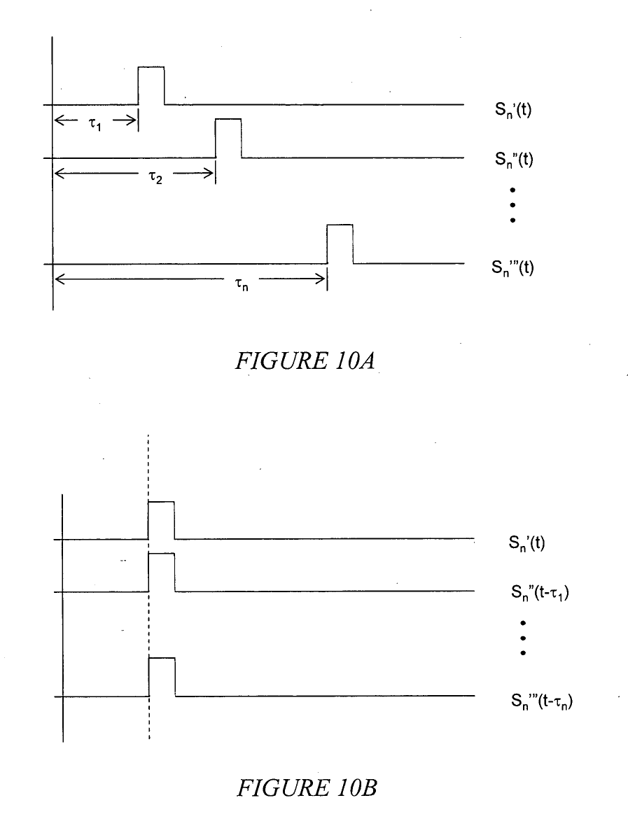

FIG. 10A illustrates more clearly the result of detected output signals Sn′(t), Sₙ″(t), Sₙ′″(t), each signal from a separate light sensor and resulting from the same transmitted symbol being received at different times at different array elements 920. Thus, each of the detected output signals includes a pulse occurring at a respective, different time delay from a common reference time. That is, Sₙ′(t) is received at a first array element 920′ with a delay TI, Sₙ″(t) is received at a second array element 920″ with a time delay τ₂, and Sₙ′″(t) is received at a third array element 920′″ with a time delay τ₃. In addition to the free-space propagation described above, the delay values can also result from additional signal routing delays experienced in the signal distribution between the array elements 120, array local processors 950, and the central processor 940.

The relative time delay values, once measured for a relatively stationary remote source 810, will remain substantially the same during subsequent operation. Thus, a calibration procedure can be used to determine the relative time delay values associated with received signals from each of the array elements 920. For example, a test signal, such as a single pulse, can be injected into all elements of the array 900 at a determinable time (e.g., a calibration pulse can be provided periodically by the remote source). As the array 900 responds to the test signal, the single pulse is received from each of the array elements with a respective delay value. As the processor 940 knows that the calibration signal was transmitted at the same time, the delay values for the array elements can be directly determined from the relative times at which they were received by the processor 940. Once determined, the relative delay values can be used by the processor to correct subsequent reception of signals from the remote source 810. Alternatively, or in addition, the delay values can be calculated based on the geometry of the array, the location of the remote source, and the interconnecting cabling or network between each of the array elements 920 and the processor. Once calculated, the delay values can similarly be used to correct subsequent reception of signals from the remote source 810. The calibration process can also be performed periodically to account for variations. For example, drift of the remote source, thermal and atmospheric differences may vary the delays associated with at least some of the elements.

While this invention has been particularly shown and described with references to preferred embodiments thereof, it will be understood by those skilled in the art that various changes in form and details may be made therein without departing from the scope of the invention encompassed by the appended claims.

1. An optical communications receiver comprising:
a plurality of spatially-separated optical detectors receiving an optical communication signal from a remote source, each optical detector further comprising:
a plurality of light sensors, and
an optical system collecting a portion of light received from the source and directing the collected portion of light toward the plurality of light sensors, the plurality of light sensors converting the collected portion of light to detected signals; and
a processor, coupled to the plurality of spatially-separated optical detectors, receiving the detected signals and combining the received signals to obtain information borne by the received optical communication signal.

2. The receiver of claim 1, wherein the plurality of light sensors comprise photon-counting sensors.

3. The receiver of claim 2, wherein the photon-counting sensors comprise avalanche photodiode sensors.

4. The receiver of claim 2, wherein the plurality of light sensors operate in nonlinear Geiger-mode.

5. The receiver of claim 1, further comprising a plurality of detector processors, each processor coupled to a respective one of the plurality of spatially-separated optical detectors for processing at least a portion of the detected communication signals.

6. The receiver of claim 1, further comprising at least one adjustable mount for pointing the plurality of spatially-separated optical detectors toward the remote source.

7. The receiver of claim 6, wherein the at least one adjustable mount is remotely controllable.

8. The receiver of claim 1, further comprising a network coupled between the plurality of spatially-separated optical detectors and the processor.

9. The receiver of claim 8, wherein the network comprises a local-area network.

10. The receiver of claim 1, wherein the plurality of light sensors are disposed on a monolithic substrate.

11. The receiver of claim 1, wherein the optical system comprises a telescope optically coupled to the plurality of light sensors.

12. The receiver of claim 11, wherein the optical system further comprises a solar baffle.

13. The receiver of claim 1, wherein the optical communication signal is modulated at a rate of at least 1 megabit per second (Mbps).

14. The receiver of claim 13, wherein the modulation is M-ary, pulse-position-modulation (M-PPM).

15. The receiver of claim 1, wherein the optical communication signal comprises an optical wavelength longer than about 1 micrometer (mm).

16. A method for receiving a free-space optical communications signal from a remote source comprising:
providing a plurality of spatially-separated optical detectors, each optical detector comprising a respective plurality of light sensors;
collecting at each of the plurality of spatially-separated optical detectors a portion of the received optical communication signal;
directing the collected portion of the received optical communication signal toward the respective plurality of light sensors;
converting at the plurality of light sensors the collected portion of the received optical communication signal to a respective detected signal; and
combining the respective detected signals from each of the plurality of spatially-separated optical detectors to obtain information borne by the received optical communication signal.

17. The method of claim 16, further comprising determining a respective delay value for each of the plurality of spatially-separated optical detectors.

18. The method of claim 17, wherein determining comprises calibrating using at least one of measuring and calculating delay values.

19. The method of claim 17, wherein determining comprises using a time reference provided within the received optical communication signal.

20. The method of claim 16, further comprising pointing the plurality of spatially-separated optical detectors toward the remote source.

21. The method of claim 20, wherein pointing comprises physically steering the spatially-separated optical detectors toward the remote source.

22. The method of claim 21, further comprising fine tuning by electronically steering the plurality of light sensors.

23. The method of claim 16, wherein converting comprises:
generating at each of the plurality of light sensors an electrical current pulse in response to detecting at least one photon;
combining at each of the plurality of spatially-separate optical detectors, the electrical current pulses forming a respective detected signal.

24. The method of claim 16, wherein combining comprises:
applying a respective delay value to each of the respective detected signals to form delay-corrected detected signals; and
aggregating the delay-corrected detected signals.

25. The method of claim 16, wherein at least some of the plurality of light sensors convert the collected portion of the received optical communication signal to a respective detected signal at different times.

26. The method of claim 16, further comprising selectively ignoring at least some of the plurality of light sensors when converting the collected portion of the received optical communication signal to a respective detected signal.

27. An optical communications receiver comprising:
means for providing a plurality of spatially-separated optical detectors, each optical detector comprising a respective plurality of light sensors;
means for collecting at each of the plurality of spatially-separated optical detectors a portion of the received optical communication signal;
means for directing the collected portion of the received optical communication signal toward the respective plurality of light sensors;
means for converting at the plurality of light sensors the collected portion of the received optical communication signal to a respective detected signal; and
means for combining the respective detected signals from each of the plurality of spatially-separated optical detectors to obtain information borne by the received optical communication signal.
